(19) United States
(12) Patent Application Publication
(10) Pub. No.: US 2006/0115758 A1
(43) Pub. Date: Jun. 1, 2006

(54) Toner including amorphous polyester, cross-linked polyester and crystalline polyester

(75) Inventors: Hui Chang, Pittsford, NY (US); Gerald P. Cox, Brockport, NY (US); Scott M. Silence, Fairport, NY (US); Juan A. Morales-Tirado, West Henrietta, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/998,822

(22) Filed: Nov. 30, 2004

(51) Int. Cl. G03G 9/087

(52) U.S. Cl. 430/109.4; 430/111.4; 430/108.4; 430/110.3

(57) ABSTRACT

A toner is disclosed that includes a binder and at least one colorant, wherein the binder includes an amorphous polyester material, a cross-linked polyester material, an optional embrittling agent material, and a crystalline polyester material. The toner may be mixed with a suitable carrier to form a developer.

### BACKGROUND OF THE INVENTION

The present invention is generally directed to a toner comprising a binder and at least one colorant, wherein the binder comprises an amorphous polyester material, a cross-linked polyester material and a crystalline polyester material, as well as to a developer containing such toner.

Toners comprised of binder resins that include a linear portion as well as a portion of cross-linked microgel particles are known. U.S. Pat. Nos. 5,227,460, 5,352,556, 5,376,494, 5,395,723 and 5,401,602, each incorporated herein by reference in its entirety, describe a low melt toner resin with low minimum fix temperature; and wide fusing latitude that contains a linear portion and a cross-linked portion of high density cross-linked microgel particles, but substantially no low density cross-linked polymer. It is described that the resin may be formed by reactive melt mixing under high shear and high temperature of an unsaturated polyester resin such as a propoxylated bisphenol A fumarate in the presence of a chemical initiator mixed into the polyester.

U.S. Pat. No. 6,063,827, incorporated herein by reference in its entirety, describes a process for the preparation of unsaturated polyester that comprises (i) reacting an organic diol with a cyclic alkylene carbonate in the presence of a first catalyst to thereby form a polyalkoxy diol, (ii) optionally adding thereto a further amount of cyclic alkylene carbonate in the presence of a second catalyst, and (iii) subsequently polycondensing the resulting mixture with a dicarboxylic acid. The unsaturated polyester formed may then be further subjected to cross-linking with an initiator as in the patents described immediately above in order to form a toner resin.

U.S. Pat. No. 6,365,316, incorporated by reference herein in its entirety, describes toners and developers for particular use in devices utilizing hybrid scavengeless development, the toners including toner particles of at least one binder, at least one colorant, and optionally one or more additives, the toner exhibiting a charge per particle diameter (Q/D) of from −0.1 to −1.0 fC/μm with a variation during development of from 0 to 0.25 fC/μm and the distribution is substantially unimodal and possesses a peak width of less than 0.5 fC/μm, and the toner has a triboelectric charge of from −25 to −70 μC/g with a variation during development of from 0 to 15 μC/g following triboelectric contact with carrier particles. The method of forming the toner having controlled properties includes feeding at least one binder and at least one colorant into a mixing device at a feed ratio, then upon exit of the mixture from the mixing device, monitoring one or more properties of the mixture with at least one monitoring device, wherein if the monitoring indicates that the one or more properties being monitored is out of specification, removing the monitored mixture from the method and adjusting the feed ratio by adjusting the feeding of the at least one binder or of the at least one colorant, thereby retaining in-specification mixture in the method, grinding the in-specification mixture, optionally together with a portion of one or more external additives to be added to the mixture, classifying the ground in-specification mixture, and mixing the classified in-specification mixture with one or more external additives to obtain the toner having controlled properties.

U.S. Pat. No. 6,359,105, incorporated by reference herein in its entirety, describes a toner resin having linear portions and cross-linked portions of high-density microgel particles, where the linear portions of the toner resin are an unsaturated polyester resin, preferably poly (propoxylated bisphenol A fumarate). The toner resin is prepared so that the cross-linked resin achieved contains less than 0.20 percent by weight of acids. In particular, the cross-linked toner resin is free of benzoic acid. The method of making the toner resin includes (a) spraying a liquid chemical initiator such as 1,1-bis (t-butyl peroxy)-3,3,5-trimethylcyclohexane onto the unsaturated polyester resin prior to, during or subsequent to melting of the unsaturated polyester resin to form a polymer melt; and (b) subsequently cross-linking the polymer melt under high shear to form the cross-linked toner resin.

U.S. Pat. No. 6,358,657, incorporated by reference herein in its entirety, describes a toner having a high colorant concentration and a binder resin that includes a polyester resin having linear portions and cross-linked portions of high density cross-linked microgel particles, which toner has a melt flow index value of about 11±3 MFI units. The binder resin may also include a mixture of two polyester resins having different MFI values.

Fixing performance of a toner can be characterized as a function of temperature. The maximum temperature at which the toner does not adhere to the fuser roll is called the hot offset temperature (HOT). When the fuser temperature exceeds HOT, some of the molten toner adheres to the fuser roll during fixing and is transferred to subsequent substrates containing developed images, resulting for example in blurred images. This undesirable phenomenon is called offsetting. Less than the HOT of the toner is the minimum fix temperature (MFT) of the toner, which is the minimum temperature at which acceptable adhesion of the toner to the support medium occurs, that is, as determined by, for example, a crease test. The difference between MFT and HOT is called the fusing latitude of the toner.

While toners comprised of polyesters including both linear and cross-linked portions have proven excellent in achieving images of high quality, and in particular of excellent gloss, such toners may still be further improved. For example, a majority of toner users employ the toners in applications in which area coverage of the toner upon a substrate is very low, e.g., 5% area coverage or less. Such low area coverage increases the average length of time that the toner resides in the developer housing. This toner aging can result in loss of developability and transfer efficiency for the toner, resulting in images of lesser quality over time.

One possible explanation for the toner-aging problem in the developer housing is impaction of the toner external additives into the surface of the toner particles. This may affect at least the toner flow properties, increasing particle-to-particle cohesion.

Other areas of performance for toners of amorphous linear polyester portions and cross-linked polyester portions that may be improved upon include increasing additive attachment strength and improving toner particle surface morphology to improve toner flow properties.

### SUMMARY OF THE INVENTION

It is thus one object of the present invention to develop a toner composition with improved strength and aging performance while maintaining existing advantageous properties such as gloss.

It is a further object of the present invention to develop a toner having improved additive attachment.

It is a still further object of the present invention to achieve a toner having improved surface morphology and flow properties.

These and other objects are achieved by various embodiments of the present invention. In one embodiment, a toner is achieved comprising a binder and a colorant, the binder including an amorphous polyester material, a cross-linked polyester material and a crystalline polyester material.

In a further embodiment, a toner further including an embrittling agent therein is achieved.

In a still further embodiment, a developer comprising the toner of embodiments of the invention and a carrier is achieved.

### BRIEF DESCRIPTION OF THE DRAWINGS

FIG. 1 illustrates the reduced cohesion achieved through incorporation of 40% by weight of a crystalline polyester in a toner.

FIG. 2 is an SEM of toner particles with no crystalline polyester in the binder, while FIG. 3 is an SEM of similar toner particles in which 40% by weight of crystalline polyester has been added.

FIGS. 4 and 5 are plots of crease fix and minimum fix temperature for toners of the invention as compared to a control toner without any crystalline polyester therein.

FIG. 6 is a plot of gloss for toners of the invention as compared to a control toner without any crystalline polyester therein.

### DETAILED DESCRIPTION OF PREFERRED EMBODIMENTS

In a first embodiment of the invention, a toner is achieved that comprises a binder and at least one colorant, wherein the binder comprises an amorphous polyester material, a cross-linked polyester material and a crystalline polyester material.

The amorphous polyester material and cross-linked polyester material of the binder will first be described. The amorphous polyester material of the binder is preferably a linear material. The cross-linked polyester material is preferably comprised of high-density cross-linked microgel particles. Although low-density cross-linked material may be present, it is most preferred that the cross-linked polyester material contain substantially no low-density cross-linked polymer.

The inclusion of the cross-linked portions is desired as these highly cross-linked dense microgel particles impart elasticity to the binder, which improves the toner offset properties while not substantially affecting the resin minimum fix temperature (MFT). With a higher degree of cross-linking or microgel content, the hot offset temperature increases. As the degree of cross-linking or microgel content increases, the low temperature melt viscosity does not change appreciably, while the high temperature melt viscosity goes up.

Illustrative examples of suitable materials selected for the amorphous polyester material include polyesters such as the polymeric esterification products of a dicarboxylic acid and a diol comprising a diphenol. The esterification product of an aliphatic alcohol and an isophthalic acid may be used. The amorphous polyester may be a homopolymer or copolymer of two or more monomers. As one resin, there are selected polyester resins derived from a dicarboxylic acid and a diphenol. These resins are illustrated in, for example, U.S. Pat. No. 3,590,000, the disclosure of which is totally incorporated herein by reference. Also, polyester resins obtained from the reaction of bisphenol A and propylene oxide or propylene carbonate, and in particular including such polyesters followed by the reaction of the resulting product with fumaric acid (reference U.S. Pat. No. 5,227,460, the disclosure of which is totally incorporated herein by reference), and branched polyester resins resulting from the reaction of dimethylterephthalate with 1,3-butanediol, 1,2-propanediol, and pentaerythritol may also preferably be used. In a most preferred embodiment, the amorphous polyester resin comprises a polypropoxylated bisphenol A fumarate polyester. A preferred linear propoxylated bisphenol A fumarate resin for this embodiment is available under the trade name SPARII from Resana S/A Industrias Quimicas, Sao Paulo Brazil. Other suitable amorphous polyester materials that are commercially available include GTUF and FPESL-2 from Kao Corporation, Japan, and EM181635 from Reichhold, Research Triangle Park, N.C.

The toner binder preferably has a weight fraction of the amorphous polyester of about 25% by weight, preferably about 25% to about 85% by weight, more preferably about 30% to about 75% by weight, of the binder.

In one preferred embodiment of the invention, the amorphous polyester material and cross-linked polyester material are comprised of the same polyester. For example, in a preferred embodiment, the amorphous polyester material is a linear polypropoxylated bisphenol A fumarate polyester while the cross-linked polyester material is comprised of cross-linked polypropoxylated bisphenol A fumarate polyester. In the embodiment in which the amorphous and cross-linked polyester materials are comprised of the same polyester, the cross-linked material may be comprised of cross-linked portions of the amorphous polyester. Thus, the amorphous and cross-linked polyester may be comprised of a resin containing both linear portions and cross-linked portions of the type described in U.S. Pat. No. 5,227,460, discussed immediately above. These resins may be prepared by either reactive extrusion as described in U.S. Pat. No. 5,227,460 or liquid reactive extrusion as described in U.S. Pat. No. 6,359,105. The cross-linked portion of the binder may consist essentially of microgel particles with an average volume particle diameter up to 0.1 micron, preferably about 0.005 to about 0.1 micron, as determined by scanning electron microscopy and transmission electron microscopy, the microgel particles being substantially uniformly distributed throughout the amorphous linear portions. The cross-linked portions are preferably highly cross-linked gel particles that are not soluble in substantially any solvent such as tetrahydrofuran, toluene and the like, and are called gel. As detailed in U.S. Pat. No. 5,227,460, the binder resin is preferably substantially free of cross-linked portions that are low in cross-linking density (therefore soluble in some solvents such as tetrahydrofuran, toluene and the like), called sol.

The amorphous and cross-linked polyester materials of the binder are thus, in one embodiment of the invention, comprised of a partially cross-linked unsaturated polyester resin. Such resin may be prepared as detailed in U.S. Pat. No. 5,227,460. The partially cross-linked polyester resin may be comprised of an unsaturated polyester prepared by cross-linking a linear unsaturated polyester base resin (hereinafter called base resin), preferably with a chemical initiator, in a melt mixing device such as, for example, an extruder at high temperature (e.g., above the melting temperature of the resin and preferably up to about 150° C. above the glass transition temperature Tg) and under high shear.

The amorphous (linear) portion of the resin preferably comprises low molecular weight reactive base resin of the same polyester used for forming the cross-linked portions. The molecular weight distribution of the polyester resin in this embodiment is thus bimodal, having different ranges for the amorphous linear portion and the cross-linked portion of the binder. The weight-average molecular weight (Mw) of the amorphous linear portion may be in the range of from, for example, about 8,000 to about 40,000. The weight average molecular weight of the gel portions is, on the other hand, not generally measurable by standard analytical techniques due to the insolubility of this portion of the resin; however, it is believed to be greater than at least 300,000.

In another embodiment of the present invention, the amorphous and cross-linked materials may be formed separately and mixed together in forming the binder resin. For example, the binder containing both of these materials may be made by mixing the amorphous, preferably linear, polyester resin with the appropriate amount of separately formed cross-linked polyester material, which may or may not be comprised of the same polyester as the amorphous polyester material.

The cross-linked polyester material preferably comprises very high molecular weight microgel particles with high density cross-linking (as measured by gel content) and which are not soluble in substantially any solvents such as, for example, tetrahydrofuran, toluene and the like. The microgel particles are highly cross-linked polymers. This type of cross-linked polymer may be formed through cross-linking of a linear unsaturated polyester with the use of a suitable chemical initiator, e.g., at high temperature and under high shear. The initiator molecule may break into radicals and reacts with one or more double bonds or other reactive sites within the polymer chain, forming a polymer radical. This polymer radical reacts with other polymer chains or polymer radicals many times, forming a highly cross-linked microgel. This renders the microgel very dense and results in the microgel not swelling very well in solvent. The dense microgel also imparts elasticity to the resin and increases its hot offset temperature while not affecting its minimum fix temperature.

The cross-linked polyester material may be a cross-linked polyester of any of the polyester materials discussed above with respect to the amorphous polyester material. Again, the cross-linked polyester material incorporated into the binder may be the same or different from the amorphous polyester material. In a preferred embodiment, the cross-linked polyester material comprises a cross-linked propoxylated bisphenol A fumarate resin.

The toner binder preferably has a weight fraction of the cross-linked polyester (microgel) (i.e., has a gel content) of at least about 1% by weight, preferably about 3% to about 50% by weight, more preferably about 5% to about 30% by weight, of the binder.

In addition to the amorphous and cross-linked polyester materials, the binder of the toner particles also includes a crystalline polyester material. By crystalline is meant that the polyester has some degree of crystallinity, and thus crystalline is intended to encompass both semicrystalline and fully crystalline polyester materials. The polyester is considered crystalline when it is comprised of crystals with a regular arrangement of its atoms in a space lattice.

The crystalline polyester is preferably a crystalline polyester resin such as detailed in U.S. Pat. Nos. 6,653,435 and 6,780,557, each incorporated herein by reference.

For example, the crystalline polyester may be obtained by polycondensing an alcohol component comprising 80% by mole or more of an aliphatic diol having 2 to 6 carbon atoms, preferably 4 to 6 carbon atoms, with a carboxylic acid component comprising 80% by mole or more of an aliphatic dicarboxylic acid compound having 2 to 8 carbon atoms, more preferably 4 to 6 carbon atoms, more preferably 4 carbon atoms. See, e.g., U.S. Pat. No. 6,780,557. The aliphatic diol having 2 to 6 carbon atoms may include ethylene glycol, 1,2-propylene glycol, 1,3-propylene glycol, 1,4-butanediol, 1,5-pentanediol, 1,6-hexanediol, neopentyl glycol, 1,4-butenediol, and the like, among which a linear alkyl diol is preferable, and 1,4-butanediol and 1,6-hexanediol are more preferable. It is desirable that the aliphatic diol is contained in the alcohol component in an amount of 80% by mole or more, preferably from 85 to 100% by mole. The alcohol component may also contain a polyhydric alcohol component other than the aliphatic diol having 2 to 6 carbon atoms. Such a polyhydric alcohol component includes a divalent aromatic alcohol such as an alkylene (2 to 3 carbon atoms) oxide adduct (average number of moles added being 1 to 10) of bisphenol A, such as polyoxypropylene (2.2)-2,2-bis (4-hydroxyphenyl) propane and polyoxyethylene (2.2)-2,2-bis (4-hydroxyphenyl) propane; a trihydric or higher polyhydric alcohol component such as glycerol, pentaerythritol and trimethylolpropane; and the like. The aliphatic dicarboxylic acid compound having 2 to 8 carbon atoms includes oxalic acid, malonic acid, maleic acid, fumaric acid, citraconic acid, itaconic acid, glutaconic acid, succinic acid, adipic acid, acid anhydrides thereof, alkyl (1 to 3 carbon atoms) esters thereof, and the like, among which fumaric acid is preferable. It is desirable that the aliphatic dicarboxylic acid compound is contained in the carboxylic acid component in an amount of 80% by mole or more, preferably from 85 to 100% by mole. Among them, from the viewpoint of the storage ability of the crystalline polyester, it is desirable that fumaric acid is contained in the carboxylic acid component in an amount of preferably 60% by mole or more, preferably 70 to 100% by mole. The carboxylic acid component may contain a polycarboxylic acid component other than the aliphatic dicarboxylic acid compound having 2 to 8 carbon atoms. Such a polycarboxylic acid component includes aromatic dicarboxylic acids such as phthalic acid, isophthalic acid and terephthalic acid; aliphatic dicarboxylic acids such as sebacic acid, azelaic acid, n-dodecylsuccinic acid and n-dodecenylsuccinic acid; alicyclic carboxylic acids such as cyclohexanedicarboxylic acid; tricarboxylic or higher polycarboxylic acids such as 1,2,4-benzenetricarboxylic acid (trimellitic acid) and pyromellitic acid; acid anhydrides thereof, alkyl (1 to 3 carbon atoms) esters thereof, and the like.

The crystalline polyester may also be derived from monomers containing an alcohol component comprising a trihydric or higher polyhydric alcohol, and a carboxylic acid component comprising a tricarboxylic or higher polycarboxylic acid compound as detailed in U.S. Pat. No. 6,653,435. The trihydric or higher polyhydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, and the like, among which glycerol is preferable from the viewpoints of the softening point and the crystallinity of the resin. Examples of the tricarboxylic or higher polycarboxylic acid compound include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, acid anhydrides thereof, alkyl (1 to 3 carbon atoms) esters thereof, and the like, among which from the viewpoints of the softening point and the crystallinity of the resin, trimellitic acid and derivatives thereof are preferable, and trimellitic acid anhydride is more preferable.

The aforementioned crystalline polyester materials are prepared by the polycondensation reactions described in the aforementioned patents.

In a preferred embodiment, the crystalline polyester material is derived from a monomer system comprised of an alcohol selected from among 1,4-butanediol, 1,6-hexanediol, and mixtures thereof with a dicarboxylic acid selected from among fumaric acid, succinic acid, oxalic acid, adipic acid, and mixtures thereof. In a most preferred embodiment, the crystalline polyester is derived from 1,4-butanediol and fumaric acid, the polyester having a crystallinity of about 25 to about 75%, more preferably about 40 to about 60%.

The crystalline polyester preferably has a melting point of preferably from 85° to 150° C., more preferably from 90° to 140° C.

In embodiments, the crystalline polymer is preferably included in the binder in an amount of from about 3 to about 60% by weight, preferably from about 5 to about 50% by weight, more preferably from about 10 to about 40% by weight of the toner.

It has been found that addition of the aforementioned crystalline polyester material to a binder also including an amorphous polyester and a cross-linked polyester imparts several advantageous properties to the binder.

For example, the inclusion of the crystalline polyester improves the level of attachment of surface additives when added with conventional blending equipment, particularly surface additives having an average particle size of from about 100 to about 500 nm. Typical and/or suitable surface additives that may be used are one or more of SiO₂, metal oxides such as, for example, TiO₂ and aluminum oxide, and a lubricating agent such as, for example, a metal salt of a fatty acid (e.g., zinc stearate (ZnSt), calcium stearate) or long chain alcohols such as UNILIN 700. In general, silica may be applied to the toner surface for toner flow, tribo enhancement, admix control, improved development and transfer stability and higher toner blocking temperature. TiO₂ may be applied for improved relative humidity (RH) stability, tribo control and improved development and transfer stability. The SiO₂ and TiO₂ may be surface treated with compounds including DTMS (dodecyltrimethoxysilane) or HMDS (hexamethyldisilazane). Examples of these additives are NA50HS silica, obtained from DeGussa/Nippon Aerosil Corporation, coated with a mixture of HMDS and aminopropyltriethoxysilane; DTMS silica, obtained from Cabot Corporation, comprised of a fumed silica, for example silicon dioxide core L90 coated with DTMS; H2050EP silica, obtained from Wacker Chemie, coated with an amino functionalized organopolysiloxane; TS530 from Cabot Corporation, Cab-O-Sil Division, a treated fumed silica; SMT5103 titania, obtained from Tayca Corporation, comprised of a crystalline titanium dioxide core MT500B, coated with DTMS.; MT3103 titania, obtained from Tayca Corporation, comprised of a crystalline titanium dioxide core coated with DTMS. The titania may also be untreated, for example P-25 from Nippon Aerosil Co., Ltd. Zinc stearate may also be used as an external additive, the zinc stearate providing lubricating properties. Zinc stearate provides developer conductivity and tribo enhancement, both due to its lubricating nature. In addition, zinc stearate can enable higher toner charge and charge stability by increasing the number of contacts between toner and carrier particles. Calcium stearate and magnesium stearate provide similar functions. Most preferred is a commercially available zinc stearate known as ZINC STEARATE L, obtained from Ferro Corporation.

The toners may contain from, for example, about 0.1 to 5 weight percent titania, about 0.1 to 8 weight percent silica and about 0.1 to 4 weight percent zinc stearate.

As discussed above, surface additives are thus required in toner formulations in order to control properties such as charging and flow. These external surface additives are added to the toner particle surface through a blending process. For example, the additive particles may be attached onto the surface of the toner particles by means of mechanical energy transferred from a rotating tool to the fluidized particles, as well as by particle-to-particle collisions. The strength of attachment of the additive particles to the toner particles thus depends upon such factors as the mechanical properties of the toner, the size of the additives, the mechanical properties of the additives, the amount of additives in the blend, and the agglomeration state of the additive particles. Process parameters such as specific energy, specific power and total shear also play a role in controlling the attachment of the additives to the surface of the toner particles. Because adjustment of process parameters is limited by the equipment, it is more preferable to adjust the physical properties of the toner and or additives in an effort to improve the strength of attachment.

It has been found in embodiments of the present invention that addition of the crystalline polyester material to the binder appropriately improves the hardness and elasticity properties of the toner particles in a manner that improves the strength of attachment of the additives to the surface of the toner particles. The strength at which additives are attached to the toner surface may be measured by determining the initial amount of additive on a toner sample and then determining how much of the additive is removed after a sonification energy is applied. In order to determine how much of the additive is removed, the toner sample is wetted and dispersed in a solution, for example, deionized water, and then sonic energy is applied by means of a probe introduced into the dispersion. The amount of additive removed from the toner surface is determined by measuring the concentration of additive in the supernatant. Following such a technique, the present inventors have found that by adding a crystalline polyester material and increasing its concentration within the binder, the amount of additives remaining on the toner surface after sonification is increased, thereby indicating that the strength of attachment of the additives to the toner particle surface is increased.

For example, a toner particle comprised of a binder with only amorphous and cross-linked polyesters may have about 35% of the additives attached to the surface of the toner particle with only very weak strength and only about 28% of the additives attached strongly, whereas toner particles of the same binder also having 40% by weight crystalline polyester added has only about 12% of the additives attached very weakly and nearly 60% of the additives attached very strongly. Quantified another way, inclusion of from about 10 to about 50% by weight of a crystalline polyester material in a toner increases the amount of external additives retained following sonification by about 10% to about 75%, as compared to the same toner without any crystalline polyester material therein.

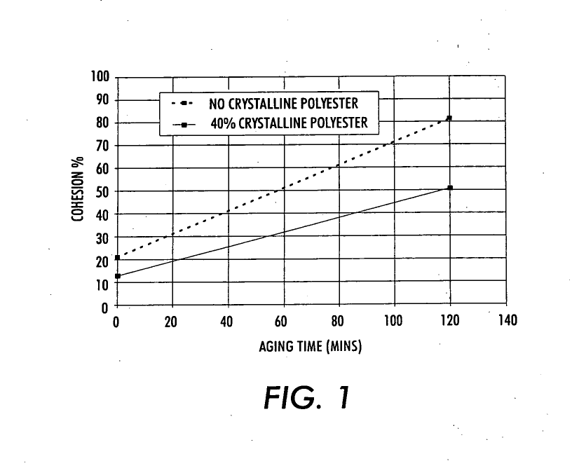

An additional benefit of the inclusion of crystalline polyester in the binder is improvement of the bulk strength of the toner particles. This may be measured by the cohesion level of the toner over time as it is aged in a fixture. Mechanically stronger materials show a lower cohesion level upon aging, indicating that the surface additives are still exposed and able to perform their release function. The increase in bulk strength to the toner particles is graphically demonstrated in FIG. 1. In general, inclusion of from about 10 to about 50% by weight of a crystalline polyester material in a toner reduces the cohesion by about 1 to about 25% with no aging and by about 10% to about 75% after at least about 2 hours of aging, as compared to the same toner without any crystalline polyester material therein.

A benefit of embodiments of the invention is thus the ability to increase toner bulk strength and toner surface additive attachment strength without having to implement any changes in existing equipment.

Still further, addition of the crystalline polyester material surprisingly modifies the surface morphology of the toner particles comprised of a binder of amorphous polyester and cross-linked polyester. Specifically, the addition of the crystalline polyester results in smoother, rounder toner particles being desirably achieved, which toner particles have improved flow properties. One methodology for measuring the smoothness and roundness of a particle is to use the Sauter mean diameter. Changes in the surface area per unit volume of a toner can be identified by looking at the Sauter mean diameter (D₃₂). This represents the particle diameter (assuming a sphere) having a surface area per unit volume equivalent to that of the whole material. For an equivalent volume median, a larger D₃₂ value suggests less surface area per unit volume. A comparison of a toner comprising 0% by weight crystalline polyester to a toner comprising 20% by weight crystalline polyester (again CPES-A2), both having a volume median D₅₀ of 7.6 microns, indicates that the toner containing crystalline polyester has a D₃₂ value of 6.8 while the toner containing no crystalline polyester has a D₃₂ value of only 6.5. More generally, a toner including from about 10 to about 50% by weight of a crystalline polyester material exhibits a Sauter mean diameter that is from about 1 to about 15% increased as compared to the same toner without any crystalline polyester therein, each with an equivalent average toner particle size. This indicates that by inclusion of the crystalline polyester, the resulting toner has a surface area per unit volume that is lower.

The surface properties of a toner particle play an important role in properties such as flowability, dispersability, wettability, sintering capability, particle size distribution, bulk density, electromagnetic properties, and catalyst reactivity of the toner particles. It has been found by the inventors that when the toner binder comprises a blend of crystalline, amorphous and cross-linked polyester resins, the surface morphology of toner particles may be advantageously improved in conventional size reduction equipment utilizing mechanical treatment (e.g., grinding) to form the toner particles. The inclusion of the crystalline polyester is believed to allow for both size reduction and surface modification simultaneously, thereby eliminating the need for additional equipment or unit operations.

It is believed that the use of a toner binder comprising a blend of each of a crystalline polyester, an amorphous polyester, and a cross-linked polyester results in tougher particles that are more resistant to breakage.

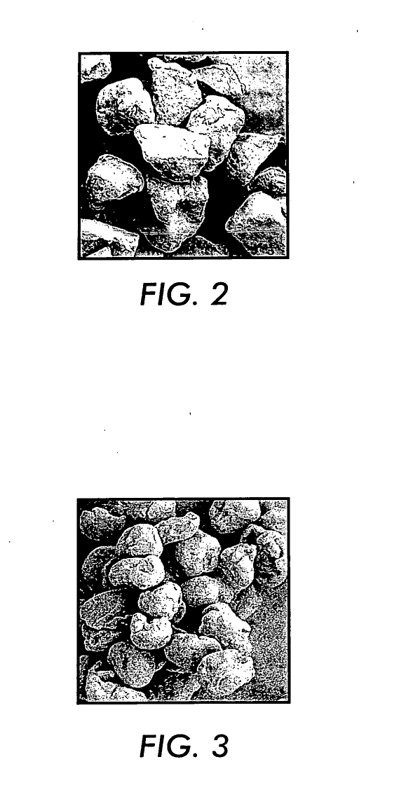

FIG. 2 is a scanning electron microscopy (SEM) of a toner particle comprised of 3.8% by weight cyan pigment, 28% by weight cross-linked polyester, and 68.2% by weight amorphous polyester. The amorphous and cross-linked polyesters were each a propoxylated bisphenol A fumarate. FIG. 3 on the other hand, is an SEM of toner particles comprised of 40% by weight crystalline polyester, 3.8% by weight cyan pigment, 28% by weight cross-linked polyester (CPES-A2, discussed below) and 28.2% by weight amorphous polyester. As can be seen in comparing FIGS. 2 and 3, the inclusion of the crystalline polyester in the toner binder results in a potato shaped toner particle having a smoother surface and smaller particle size. This results in the toner particles having better flow properties, potentially eliminating the need for flow aids at grind, and thus potentially requiring less surface additives to achieve an equivalent surface area coverage for the same flow property.

It has also been found that the crystalline polyester material is an excellent compliment to the cross-linked polyester material. For example, while the inclusion of the cross-linked polyester in higher amounts lowers the gloss of the toner, addition of the crystalline polyester material in higher amounts can increase the gloss of the toner. Further, addition of the cross-linked polyester material in higher amounts increases the minimum fixing temperature (MFT) of the toner, while addition of the crystalline polyester material in higher amounts lowers the MFT of the toner. This balancing of properties between the cross-linking polyester and the crystalline polyester enables the end toner to have excellent fusing latitude, i.e., an excellent balance of low MFT and high hot offset resistance, such that high quality images are formed at typical fusing temperatures without offset (i.e., minimal sticking of toner to the fusing roll).

Toners of the invention can thus provide a low melt toner with a MFT of from about 60° C. to about 200° C., preferably about 80° C. to about 160° C., more preferably about 80° C. to about 140° C. The toners also have a wide fusing latitude. The toners preferably have a fusing latitude greater than 10° C., preferably from about 10° C. to about 120° C., and more preferably more than about 20° C. and even more preferably more than about 30° C. Such toners thus exhibit little to no offset over a wider range of fusing temperatures.

As was discussed in the background section above, use of toners in low area coverage printing increases the average length of time the toner particles must reside in the developer housing. While it might be possible to address toner aging by reducing the mechanical and electrical abusive conditions within the developer housing, such is difficult as it sacrifices machine performance. Embodiments of the present invention are thus quite advantageous in addressing the aging problem in low area coverage printing through toner property adjustments. Specifically, toners of embodiments of the present invention have higher strength and higher surface additive attachment as discussed above, which reduces the toners susceptibility to aging, (i.e., susceptibility to the surface additives becoming impacted into the source of the toner particle, which reduces toner flow and performance of the toner).

In embodiments of the present invention, the crystalline polyester material is included, which crystalline polyester material preferably exhibits a sharp drop in viscosity with increased temperature, preferably a sharp drop in viscosity above, for example, 110° C. Including a crystalline polyester in the toner results in a sharp drop in the viscosity of the toner above the melting temperature of the crystalline material. This allows the toner to reach a minimum viscosity at temperatures of from 5° C. to 50° C. lower than the same toner not containing any crystalline polyester material. That is, addition of from about 10 to about 50% by weight of crystalline polyester material advantageously reduces the MFT by from about 5 to about 50° C., as compared to the same toner without any crystalline polyester material therein. This has the advantageous effect of reducing the MFT of the toner that includes a crystalline polyester. Lowering the operating temperatures within the image-forming device as a result of the toner having a lower MFT increases fuser roll life and may also result in an increase of paper throughput.

In addition, inclusion of the crystalline polyester results in an increase in mechanical strength of a toner below the toner melting temperature. This not only improves aging resistance and flow properties as discussed above, it also improves image permanence. For example, an amorphous polyester may lose its mechanical strength gradually above its glass transition temperature. As the melting temperature of the crystalline polyester material is preferably above the glass transition temperature of the amorphous material, the crystalline polyester material maintains a higher mechanical strength at a higher temperature compared to the amorphous polyester material alone.

Further, because of the lower viscosity of a toner including a crystalline polyester therein, such allows for the toner to possibly include a greater amount of cross-linked polyester material than previously possible. Addition of greater amounts of cross-linked polyester material alone improves the hot offset resistance of the toner, but adversely increases the viscosity and fusing temperatures of the toner. These effects can be offset by including the crystalline polyester material, thereby allowing the toner to include more cross-linked polyester and thus to have improved hot offset resistance, yet still be fused at a similar temperature.

Similarly, through inclusion of the crystalline polyester material, it is possible to increase the glass transition temperature of the amorphous polyester material. While this increases the viscosity of the toner, such is offset by the decrease in viscosity as a result of the inclusion of the crystalline polyester. By increasing the glass transition temperature of the amorphous polyester material, document offset resistance can be boosted, permitting the toners to be used in applications where post image formation temperature resistance is required.

It has also been found that while a toner binder comprised of only an amorphous polyester material and a cross-linked polyester material behave as brittle materials below the glass transition temperature of the toner, addition of a crystalline polyester material to the toner blend enables the toner to behave as a ductile material at the same temperatures.

Table 1 below summarizes several example toners of the invention as with control/comparative examples for properties such as melt flow index (MFI) and document offset.

TABLE 1

| | | | % | | | | Blend | |
|---|---|---|---|---|---|---|---|---|
| | | Crystalline | Amorphous | Tg of | % | % | MFI | Document |
| | | Polyester | polyester in | Amorphous | Cross- | Crystal- | @ | Offset |
| Example | Color | Type | toner | polyester(⁰ C.) | linked | line | 125° C. | T − T/T − P |
| Control | Cyan | | 59.03 | 57 | 28.3 | 0 | 20.9 | 1.00/1.00 |
| 1 | Cyan | CPES-1 | 39.03 | 57 | 28.3 | 20 | 56.8 | 1.50/2.25 |
| 2 (Comp.) | Cyan | | 59.03 | 53 | 28.3 | 0 | 47.4 | 1.00/1.00 |
| 3 | Cyan | CPES-1 | 19.03 | 53 | 28.3 | 40 | 79.8 | 4.50/5.00 |
| 4 (Comp.) | Cyan | | 59.03 | 62 | 28.3 | 0 | 8.6 | 1.00/4.25 |
| 5 | Cyan | CPES-1 | 19.03 | 62 | 28.3 | 40 | 10.5 | 5.00/4.50 |
| 6 | Cyan | CPES-A1 | 19.03 | 53 | 28.3 | 40 | 116.1 | 4.25/4.00 |
| 7 | Cyan | CPES-A1 | 19.03 | 62 | 28.3 | 40 | 81.6 | NA |
| 8 | Cyan | CPES-A2 | 19.03 | 53 | 28.3 | 40 | 2.7 | 4.75/3.75 |
| 9 | Cyan | CPES-A2 | 19.03 | 62 | 28.3 | 40 | 1.9 | 4.50/4.50 |
| 10* | Cyan | CPES-A3 | 49.33 | 62 | 20.0 | 10 | 29.7 | 1.00/3.00 |
| 11* | Cyan | CPES-A3 | 5.30 | 62 | 54.0 | 20 | 30.0 | 3.75/3.50 |

*Includes 8% FTR 6125 (discussed more fully below) as an embrittling agent.

In the above Table 1, CPES-1, CPES-A1, CPES-A2 and CPES-A3 represent crystaline polyesters derived from 1-4-butanediol and fumaric acid with various monomer ratios and molecular weights. The amorphous polyester is a propoxylated bisphenol A fumarate resin.

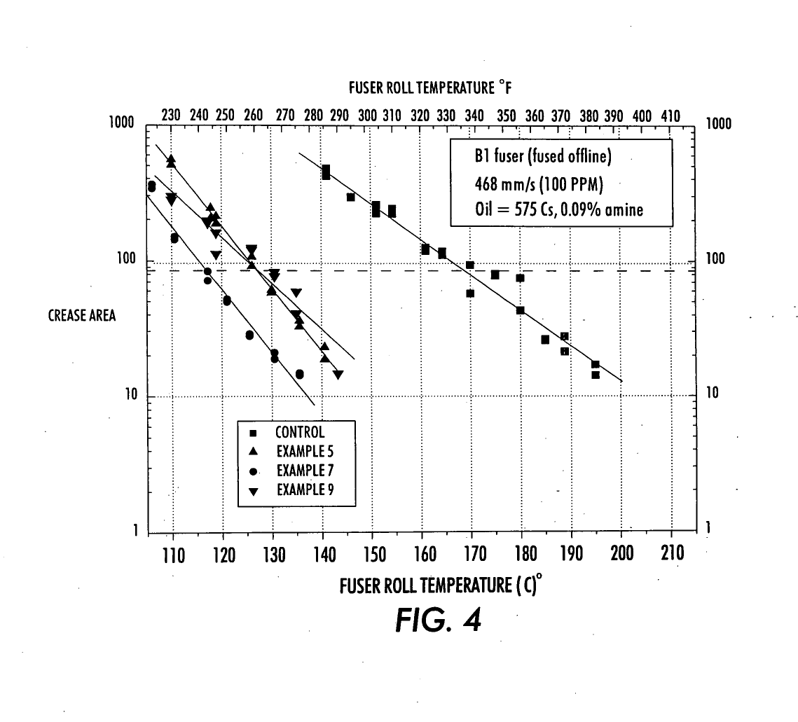

Further, FIG. 4 shows a plot of minimum fixing temperature and crease area of example toners 5, 7 and 9 as compared to the control toner. Note that the minimum fixing temperature of toners of the invention containing crystalline polyester is more than 40° C. less than the control toner.

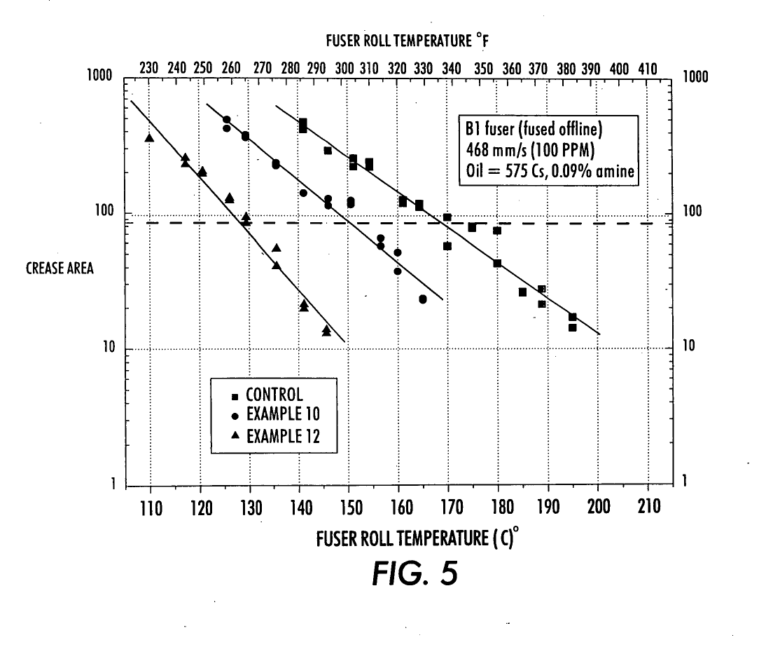

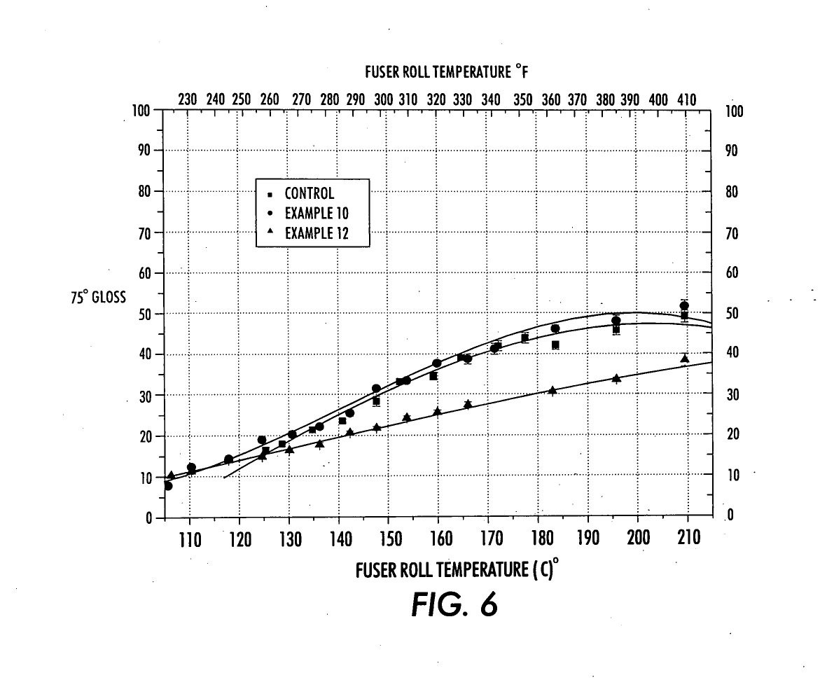

FIG. 5 illustrates similar plotted data for toners including CPES-A3 (available from Kao Corporation) as the crystalline polyester along with 8% by weight of an embrittling agent (FTR 6125). The first toner includes 10% by weight of the crystalline polyester, while the second toner includes 20% by weight of the same crystalline polyester. As can be seen in FIG. 5, increasing the percentage of the crystalline polyester decreases the minimum fixing temperature. Also, for toners with matched rheology, gloss is lower for higher percentages of crystalline polyester and cross-linked polyesters at the same melt flow index, but this may be varied by adjusting the rheology using the amount of cross-linked polyester. See FIG. 6. Lower loadings (e.g., 20%) of crystalline polyester material improve tribo, grind rate and gloss while higher loadings are desirable for ultra low minim fixing temperature (MFT) and document offset performance.

It has been found that a toner binder comprised of an amorphous polyester material, a cross-linked polyester material and a crystalline polyester material improves document offset or image permanence performances drastically. Toner-to-toner document offset is controlled by the percent loading of crystalline polyester material, more crystalline polyester resulting in less or no damage. The main drivers for toner-to-paper document offset are the amorphous polyester glass transition temperature and also the crystalline polyester percentage, higher values producing less damage.

Document offset samples were imaged onto 90 gsm CX+ paper at 0.48 mg/cm² using a DC265 printer and a developer charge of 40 grams of toner and 760 grams of 90 micron carrier. The unfused images are then run through a B1 fuser with the fuser roll temperature set to MFT_{CA=85}+10° C. or a maximum fuser roll temperature of 210° C. Toner-to-toner and toner-to-paper sections for document offset testing were cut from the sheet, 5 cm by 5 cm , and placed in an environmental chamber under a 80 g/cm² load at 60° C. and 50% RH for 24-hours. Document offset was evaluated and quantified using IQAF software (default settings) on images scanned with a UMAX PowerLook III flatbed scanner (gamma=1). A rank of 5 indicates the sample was not damaged while a rank of 1 indicates significant amounts of damage. The image analysis system is used to provide more quantitative results; the lower percentage toner values in Table 1 above indicate less damage. It is important to note that the IQAF results are very dependent on thresholding. The optimum thresholding has not been determined for document offset. Results should be taken as a consistent relative ranking.

The control and comparative toners had poor toner to toner (T-T) and toner to paper (T-P) document offset performance, as indicated in Table 1. Sample toners of the invention, however, indicated improved document offset performance. For example, toners with 40% crystalline polyester had excellent toner-toner and toner-to-paper document offset, with almost no damage found. Decreasing the crystalline polyester to 10% resulted in poorer toner-to-toner document offset (rank of 1) while some toner-to-paper damage was observed (rank of 2.25 to 3). Toners made with higher glass transition temperature amorphous resins resulted in less toner-to-paper document offset damage. All example toners were made with an embrittling agent. Increasing the amount of crystalline polyester in these toners from 10% to 20% greatly improved toner-to-toner document offset.

In a preferred embodiment, toners of the invention exhibit toner-to-toner offset ranking of from 3 to 5 and a toner-to-paper offset of from 3 to 5.

The toner particles of embodiments of the invention may be made by melt blending or otherwise mixing each of the binder components with a colorant (e.g., pigment or dye), as well as with any other optional additives including charge carrier additives, surfactants, emulsifiers, pigment dispersants, flow additives, embrittling agents, and the like. The resultant product can then be pulverized by known methods such as grinding/milling to form the toner particles. If desired, waxes with a low molecular weight, e.g., of from about 500 to about 20,000, such as polyethylene, polypropylene, and paraffin waxes, can be included in or on the toner, for example as fusing release agents.

It has been found that as a result of the inclusion of the crystalline polyester material, the strength of the toner is improved as discussed above. As a result of this increased strength, however, it is necessary to conduct longer and/or more intense grinding in order to achieve toner particles having the desired end toner particle size. To improve this, it is preferable in embodiments to include in the binder blend at least one embrittling agent. Any suitable embrittling agent may be used without restriction. For example, the embrittling agent may be an aromatic hydrocarbon polymer, for example as described in U.S. Pat. Nos. 5,972,547 and 5,458,642, which polymers are incorporated herein by reference. Suitable commercially available embrittling agents include, for example, FMR0150 and FTR 6125 and FTR 2120 from Mitsui Chemical Company, Japan, and FT-11-83 from Neville Chemical Company, Pittsburgh, Pa. The embrittling agent is preferably added in an amount of from, for example, about 1 to about 15% by weight, preferably from about 3 to about 10% by weight, of the binder.

Various suitable colorants of any color without restriction can be employed in toners of the invention, for example carbon black, magnetite, or mixtures thereof, cyan, magenta, yellow, blue, green, red, orange, violet or brown, or mixtures thereof, including suitable colored pigments, dyes, and mixtures thereof including Carbon Black, such as REGAL 330 carbon black (Cabot), Acetylene Black, Lamp Black, Aniline Black, Diarylide Yellow, SUNFAST YELLOW, POLYTONE YELLOW, Arylide Yellow, Chrome Yellow, Zinc Yellow, SICOFAST YELLOW, SUNBRITE YELLOW, LUNA YELLOW, NOVAPERM YELLOW, Chrome Orange, BAYPLAST ORANGE, Cadmium Red, LITHOL SCARLET, Rubines, Quanacridones, RHODAMINE LAKE C, SUNTONE MAGENTA, POLYTONE MAGENTA, HOSTAPERM RED, FANAL PINK, HOSTAPERM PINK, LITHOL RED, RHODAMINE LAKE B, Brilliant Carmine, SUNTONE CYAN, POLYTONE CYAN, HELIOGEN BLUE, HOSTAPERM BLUE, NEOPAN BLUE, PV FAST BLUE, Phthalocyanine Blue, CINQUASSI GREEN, HOSTAPERM GREEN, titanium dioxide, cobalt, nickel, iron powder, SICOPUR 4068 FF, and iron oxides such as MAPICO BLACK (Laporte Pigments, Inc.), NP608 an NP604 (Northern Pigment), BAYFERROX 8610 (Bayer), M08699 (Mobay), TMB-100 (Magnox), mixtures thereof and the like. This list is not exhaustive, and any colorant or combination of colorants may be used without restriction. The colorant is preferably incorporated in an amount of at least about 2% by weight of the toner, preferably about 4% by weight to about 30% by weight of the toner, exclusive of any surface additives. The weight percentage of the colorant refers to the actual weight percentage of the pigment or dye only, and not to any weight from binder or other components possibly added along with the colorant.

For enhancing the negative charging characteristics of a developer composition, there can be incorporated into the toner or on its surface a charge enhancing aluminum complex, like BONTRON E-88 and other similar known charge enhancing additives. Also, positive charge enhancing additives may also be selected, such as alkyl pyridinium halides, reference U.S. Pat. No. 4,298,672; organic sulfate or sulfonate compositions, reference U.S. Pat. No. 4,338,390; distearyl dimethyl ammonium sulfate; bisulfates, and the like. These additives may be incorporated into the toner in an amount of from about 0.1 percent by weight to about 20 percent by weight, and preferably from 1 to about 3 percent by weight.

While any desired toner particle size may be used, in a preferred embodiment of the invention, the finished toner particles have an average particle size (volume median diameter) of from about 3.0 to about 12.0 microns, more preferably of from about 5.0 to about 9.0 microns, as measured by the well known Coulter counter technique. The toner preferably also exhibits a narrow particle size distribution with a lower volume ratio geometric standard deviation (GSD) of approximately 1.30 or less.

The toner particles of all embodiments of the invention are preferably formulated into a developer composition. Preferably, the toner particles are mixed with carrier particles to achieve a two-component developer composition. Preferably, the toner concentration in each developer ranges from, for example, 1 to 25%, more preferably 2 to 15%, by weight of the total weight of the developer.

Illustrative examples of carrier particles that can be selected for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Additionally, there can be selected as carrier particles nickel berry carriers as disclosed in U.S. Pat. No. 3,847,604, comprised of nodular carrier beads of nickel, characterized by surfaces of reoccurring recesses and protrusions thereby providing particles with a relatively large external area. Other carriers are disclosed in U.S. Pat. Nos. 4,937,166 and 4,935,326.

The selected carrier particles can be used with or without a coating, the coating generally being comprised of fluoropolymers, such as polyvinylidene fluoride resins, terpolymers of styrene, methyl methacrylate, a silane, such as triethoxy silane, tetrafluoroethylenes, other known coatings and the like. Where toners of the present invention are to be used in conjunction with an image developing device employing roll fusing, the carrier core may preferably be at least partially coated with a polymethyl methacrylate (PMMA) polymer having a weight average molecular weight of 300,000 to 350,000, e.g., such as commercially available from Soken. The PMMA is an electropositive polymer in that the polymer that will generally impart a negative charge on the toner with which it is contacted. The coating preferably has a coating weight of from, for example, 0.1 to 5.0% by weight of the carrier, preferably 0.5 to 2.0% by weight. The PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with from, for example, between about 0.05 to about 10 percent by weight, more preferably between about 0.05 percent and about 3 percent by weight, based on the weight of the coated carrier particles, of polymer until adherence thereof to the carrier core by mechanical impaction and/or electrostatic attraction. Various effective suitable means can be used to apply the polymer to the surface of the carrier core particles, e.g., cascade roll mixing, tumbling, milling, shaking, electrostatic powder cloud spraying, fluidized bed, electrostatic disc processing, and with an electrostatic curtain. The mixture of carrier core particles and polymer is then heated to enable the polymer to melt and fuse to the carrier core particles. The coated carrier particles are then cooled and thereafter classified to a desired particle size.

The carrier particles can be mixed with the toner particles in various suitable combinations. However, best results are obtained when about 1 part to about 5 parts by weight of toner particles are mixed with from about 10 to about 300 parts by weight of the carrier particles.

In embodiments of the present invention. any known type of image development system may be used in an image developing device, including, for example, magnetic brush development, jumping single-component development, hybrid scavengeless development (HSD), etc. These development systems are well known in the art, and further explanation of the operation of these devices to form an image is thus not necessary herein. Once the image is formed with toners/developers of the invention via a suitable image development method such as any one of the aforementioned methods, the image is then transferred to an image receiving medium such as paper and the like. In an embodiment of the present invention, it is desired that the toners be used in developing an image in an image-developing device utilizing a fuser roll member. Fuser roll members are contact fusing devices that are well known in the art, in which heat and pressure from the roll are used in order to fuse the toner to the image-receiving medium. Typically, the fuser member may be heated to a temperature of from about 125° C. to about 200° C.

Although the invention has been described with reference to specific preferred embodiments, it is not intended to be limited thereto. Rather those having ordinary skill in the art will recognize that variations and modifications may be made therein which are within the spirit of the invention and within the scope of the claims.

What is claimed is:

1. A toner comprising a binder and at least one colorant, wherein the binder comprises an amorphous polyester material, a cross-linked polyester material and a crystalline polyester material.

2. The toner according to claim 1, wherein the amorphous polyester material comprises one or more of a propoxylated bisphenol A fumarate, and an esterification product of an aliphatic alcohol and an isophthalic acid.

3. The toner according to claim 1, wherein the amorphous polyester material is linear.

4. The toner according to claim 1, wherein the binder includes from about 25 to about 85 percent by weight of the toner of the amorphous polyester material.

5. The toner according to claim 1, wherein the cross-linked polyester material comprises one or more of a propoxylated bisphenol A fumarate, and an esterification product of an aliphatic alcohol and an isophthalic acid.

6. The toner according to claim 1, wherein the binder includes from about 3 to about 50 percent by weight of the toner of the cross-linked polyester material.

7. The toner according to claim 1, wherein the crystalline polyester material comprises a polyester derived from the reaction of an aliphatic diol and an aliphatic dicarboxylic acid.

8. The toner according to claim 1, wherein the crystalline polyester material comprises a polyester derived from the reaction of (a) 1,4-butanediol, 1,6-hexanediol, or mixtures thereof with (b) fumaric acid, oxalic acid, adipic acid, succinic acid, or mixtures thereof.

9. The toner according to claim 1, wherein the binder includes from about 3 to about 60 percent by weight of the crystalline polyester material.

10. The toner according to claim 1, wherein the amorphous polyester material and the cross-linked polyester material are comprised of the same polyester.

11. The toner according to claim 10, wherein the cross-linked polyester material comprises cross-linked portions of the amorphous polyester material.

12. The toner according to claim 1, wherein the toner further comprises an embrittling agent.

13. The toner according to claim 11, wherein the embrittling agent is included in an amount of from about 1 to about 15 weight percent of the toner.

14. The toner according to claim 12, wherein the embrittling agent is one or more aromatic hydrocarbon polymers.

15. The toner according to claim 1, wherein the colorant is a pigment or a dye.

16. The toner according to claim 1, wherein the toner further comprises one or more external surface additives.

17. The toner according to claim 16, wherein at least one of the external surface additives has an average particle size of about 100 to about 500 nm.

18. The toner according to claim 16, wherein the external surface additive is one or more of silicon dioxide, titanium dioxide, aluminum oxide and zinc stearate.

19. A toner comprising a binder and at least one colorant, wherein the binder includes from about 10 to about 50% by weight of a crystalline polyester material, and wherein the toner exhibits
a cohesion reduced by about 10% to about 75% after at least about 2 hours of aging as compared to a same toner without any crystalline polyester material therein,
a minimum fix temperature reduced by from about 5 to about 50° C. as compared to the same toner without any crystalline polyester material therein,
a toner-to-toner offset ranking of from 3 to 5 and a toner-to-paper document offset of from 3 to 5, and
a Sauter mean diameter increased by about 1% to about 15% as compared to the same toner having an equivalent average toner particle size and without any crystalline polyester material therein.

20. The toner according to claim 19, wherein the toner further comprises one or more external surface additives, and wherein the an amount of the external additives retained following sonification is about 10% to about 75% greater as compared to a same toner without any crystalline polyester material therein.

21. A developer comprising a toner comprising a binder and at least one colorant, wherein the binder comprises an amorphous polyester material, a cross-linked polyester material and a crystalline polyester material, and a carrier.
